(19) United States
(12) Patent Application Publication
(10) Pub. No.: US 2003/0008941 A1
(43) Pub. Date: Jan. 9, 2003

(54) Ink-jet ink capable of creating high optical density images

(76) Inventors: Yi-Jing Leu, Hsinchu (TW); Yu-Chang Shen, Taipei (TW); In-Shan Sir, Kaohsiung (TW); Chia-Hsin Chien, Taoyuan (TW)

Correspondence Address: RABIN & BERDO, P.C., SUITE 500, 1101 14th STREET, N.W., WASHINGTON, DC, 20005, US

(21) Appl. No.: 10/151,035

(22) Filed: May 21, 2002

(30) Foreign Application Priority Data
May 21, 2001 (TW) 90112163

(51) Int. Cl. C03C 17/00; C09D 5/00

(52) U.S. Cl. 523/160; 523/161

(57) ABSTRACT

An ink-jet ink including at least polyethylene glycol fatty acid ester, glycol, a colorant, a surfactant and a humectant is disclosed. The ink-jet ink of the invention provides for prints of fast drying, higher adhesion of the ink drop to the media, better water fastness and higher optical density. Moreover, clogging and blockage of the ink nozzle can be prevented.

This application incorporates by reference of Taiwan application Serial No. 90112163, filed May 21, 2001.

### BACKGROUND OF THE INVENTION

1. Field of the Invention

The invention relates in general to an ink-jet ink, and more particularly to an ink-jet ink including polyethylene glycol fatty acid ester and glycol.

2. Description of the Related Art

Ink-jet printing technology is well developed and has the advantages of low cost, low noise and being capable of providing full-color prints with ease. Further more, a high-quality printed image can be produced not only on specialty recording media, but also on inexpensive plain papers and transparency films.

Various properties are required of inks in the ink-jet recording, and examples of such properties include fast drying of the printed image, vividness of the colorant, high optical density, fast printing speed, freedom from feathering in the printed image, freedom from color-to-color bleeding in the case of multi-color printing, and good water fastness and light fastness of the print.

One weak point of the ink-jet ink is that printed ink is hard to dry since the ink used for ink-jet recording is usually a water base ink. Enhancing the penetration of the ink could result in high speed drying of the ink. Adding agent with high volatility is an alternative way. However, ink added with high-volatility agents could form a crust over the tip of an ink-jet nozzle, which stops the printer from working.

A dye and a pigment are two common colorants. Ink compositions using a dye as the colorant are generally designed to dry easily in one second. On the other hand, ink composition using a pigment as the colorant normally takes more time to dry since the particles of the pigments are larger.

Optical density (OD) is an index of printing quality. Optical density of various points of a printed image can be measured by using a densitometer or colorimeter. Optical density measurements are performed by illuminating a test image with a light source and measuring the intensity of the light reflected from the image. Optical density (D) is defined as:

OD=log(Io/I)

where Io is incident light intensity and I is the reflected light intensity.

Images with high optical density, absorbing most of the incident light and reflecting less light, result in better image quality. On the other hand, images with low optical density reflect most light, which therefore result in worse image quality.

### SUMMARY OF THE INVENTION

It is therefore an object of the invention to provide an ink-jet ink providing for prints of fast drying, higher adhesion of the ink drop to the media, better water fastness and higher optical density but without causing clogging and blockage of the ink nozzle.

The invention achieves the above-identified objects by providing a composition of an ink-jet ink, which comprises polyethylene glycol fatty acid ester, glycol with a molecular weight less than 5000, a colorant, and a solvent.

Polyethylene glycol fatty acid ester in the ink-jet ink of the invention is selected from the group consisting of polyethylene glycol mono-oleate(PEGMO), polyethylene glycol di-oleate(PEGDO), polyethylene glycol mono-stearate(PEGMS), polyethylene glycol di-stearate(PEGDS), polyethene glycol mono-laurate(PEGML), polyethene glycol di-laurate(PEGDL), polyethylene glycol mono-tallate(PEGMT), and polyethylene glycol di-tallate(PEGDT). The amount of polyethylene glycol fatty acid ester is about 0.01 wt %˜15.0 wt % and the molecular weight of polyethylene glycol of polyethylene glycol fatty acid ester is less than 1500.

Glycol in the ink-jet ink of the invention is selected from the group consisting of ethylene glycol, diethylene glycol, and polyethylene glycol. The amount of glycol is about 0.01 wt %˜7.00 wt %.

The colorant in the ink-jet ink is a disperse pigment with a particle size in the range between 0.001 μm and 1.0 μm. The amount of the disperse pigment is in the range between 1.0 wt % and 10.0 wt %.

The ink-jet ink of the invention further comprises a dispersing agent and an adhesion agent. The solvent is an aqueous solvent such as water. The amount of the aqueous solvent is in the range between 50.0 wt % and 95.0 wt %.

The ink-jet ink of the invention can further comprise aqueous organic solvent, inorganic salt, a surfactant, a humectant, biocide and buffer. The amount of the surfactant is in the range between about 0.1 wt % and 10.0 wt %. The amount of the humectant is a water-soluble organic compounds with low volatility.

### DETAILED DESCRIPTION OF THE INVENTION

An ink-jet ink according to a preferred embodiment of the invention at least includes: polyethylene glycol fatty acid ester, glycol and colorant, which are all solved in an aqueous solvent. Preferably, surfactant, humectant or biocide is added in the ink-jet ink of the invention.

Polyethylene glycol fatty acid ester added in the ink-jet ink is preferably in the range between 0.01 wt % and 15.0 wt %. Polyethylene glycol fatty acid ester can be any one or any combination of the following: polyethylene glycol mono-oleate (PEGMO), polyethylene glycol di-oleate (PEGDO), polyethylene glycol mono-stearate (PEGMS), polyethylene glycol di-stearate (PEGDS), polyethene glycol mono-laurate(PEGML), polyethene glycol di-laurate(PEGDL), polyethylene glycol mono-tallate (PEGMT) and polyethylene glycol di-tallate (PEGDT). The molecular weight of polyethylene glycol (PEG) is preferably less than 1500. PEG400DO, PEGDO with PEG having a molecular weight of 400, is an example of preferred polyethylene glycol fatty acid ester.

Polyethylene glycol fatty acid ester effectively reduces the surface tension of the ink that uses pigments as a colorant so that the ink is able to dry fast. Moreover, polyethylene glycol fatty acid ester enhances the adhesion of the pigments to the media, provides better water fastness and rub fastness.

The molecular weight of glycol added in the ink of the invention is preferably less than 5000 and the amount thereof is about 0.01 wt % to 7 wt %. Glycol can be any one or any combination of the following: ethylene glycol, diethylene glycol, and polyethylene glycol. Glycol increases the optical density of the ink dropped in the media, in addition to acting as humectants.

Small particle disperse pigments with sizes between about 0.001 μm and 1.0 μm are preferred. The amount of the pigments can be between about 1.0 wt % and 10.0 wt % and preferably between 1.0 wt % and 5.0 wt %. Pigments enhances the water fastness and light fastness of the ink but it is better to be applied together with a dispersing agent and an adhesion agent to prevent precipitate and the consequential blockage of the nozzle.

The aqueous solvent of the ink according to a preferred embodiment of the invention can be water, in the amount of 50.0 wt %˜95.0 wt %, preferably in the amount of 70.0 wt %˜90.0 wt %. In addition, other solvent like organic solvent and inorganic salt can be also applied to enhance the penetration and dispersion of the ink.

One or more than one surfactants can be added to adjust the viscosity for smooth ink supply and ink-jet and to adjust the surface tension of the ink to prevent feathering. Moreover, surfactants also enhance the penetration and dispersion of the ink. Surfactants applied in the ink of the invention can be anionic, nonionic, cationic or amphoteric surfactants. The total amount of the surfactant is less than 15.0 wt %, preferably 0.1 wt %˜10.0 wt %.

To prevent the clogging of the nozzle, humectants can be added because humectants slow down the speed of ink evaporation. Humectants can be water-soluble organic compounds with low volatility. The preferred amount thereof is about 0.1 wt %˜10.0 wt %.

Biocide is one of the preferred additives. Biocide inhibits the growing of the bacteria. Buffer is another preferred additive. Buffer keeps the ink in a range of suitable pH value to express ideal colors.

It is well known to persons skilled in the art that other additives which enhance light fastness or the stability in storage can also be added in the ink of the invention.

Recipes of the ink-jet ink of the invention are taken as examples and are listed as follows.

### EXAMPLE 1

The ink-jet ink capable of creating high optical density images includes at least the following:

| | |
|---|---|
| disperse carbon-black pigments | 4.0 wt % |
| surfactants | 9.0 wt % |
| humectants | 7.5 wt % |
| polyethylene glycol fatty acid ester | 3.0 wt % |
| glycol | 3.5 wt % |

Additives such as buffer and biocide can be also included. The major solvent is water. The polyethylene glycol fatty acid ester can be any one or any combination of the followings: PEGMO•PEGDO•PEGMS•PEGDS•PEGMT•PEGDT•PEGML and PEGDL. The molecular weight of the polyethylene glycol is preferably less than 1500.

Either ethylene glycol, diethylene glycol, or polyethylene glycol is added. The molecular weight of the polyethylene glycol can be 200, 600, 1000, 1500, 2000, 3000, or 4500. In table I, the ink-jet ink 1-1 is a control. Glycol is not added in the control.

Images are printed by using inks 1-1 to 1-10 as listed in Table I. Five minutes after printing, optical density of various points of the printed image is measured by using a colorimeter. Optical density measurements are performed by illuminating a test image with a light source and measuring the intensity of the light reflected from the image. Results are listed in Table I.

TABLE I

| | | Optical Density |
|---|---|---|
| No. of Inks | Glycol | (OD) |
| 1-1 | None | 1.29 |
| 1-2 | EG | 1.49 |
| 1-3 | DEG | 1.48 |
| 1-4 | PEG200 | 1.47 |
| 1-5 | PEG600 | 1.49 |
| 1-6 | PEG1000 | 1.45 |
| 1-7 | PEG1500 | 1.46 |
| 1-8 | PEG2000 | 1.45 |
| 1-9 | PEG3000 | 1.47 |
| 1-10 | PEG4500 | 1.48 |

### EXAMPLE II

The ink-jet ink of the second example of the invention can also include at least the following and others:

| | |
|---|---|
| disperse carbon-black pigments | 4.0 wt % |
| surfactants | 9.0 wt % |
| humectants | 7.5 wt % |
| polyethylene glycol fatty acid ester | 3.0 wt % |
| glycol | 3.5 wt % |

Additives such as buffer and biocide can be also included. The major solvent is water. Polyethylene glycol fatty acid ester can be any one or any combination of the followings: PEGMO, PEGDO, PEGMS, PEGDS, PEGMT, PEGDT, PEGML and PEGDL. The molecular weight of polyethylene glycol is preferably less than 1500.

Different from the inks of Example I, more than one glycol selected from ethylene glycol, diethylene glycol, and polyethylene glycol are added. The ink 2-1 is a control and not any glycol is added.

Images are printed by using inks 2-1 to 2-7 as listed in Table II. Five minutes after printing, optical density of various points of the printed image is measured by using a calorimeter. Optical density measurements are performed by illuminating a test image with a light source and measuring the intensity of the light reflected from the image. Results are listed in Table II.

TABLE II

| | | Optical Density |
|---|---|---|
| No. of Inks | Glycol | (OD) |
| 2-1 | None | 1.29 |
| 2-2 | 2% EG + 1.5% DEG | 1.49 |
| 2-3 | 2% EG + 1.5% PEG200 | 1.47 |
| 2-4 | 2% PEG200 + 1.5% PEG600 | 1.49 |
| 2-5 | 2% DEG + 1.5% PEG1500 | 1.46 |
| 2-6 | 2% PEG600 + 1.5% PEG2000 | 1.45 |
| 2-7 | 2% PEG1000 + 1.5% PEG4500 | 1.48 |

It is therefore apparent that the ink-jet ink with polyethylene glycol fatty acid ester effectively increases the optical density of the printed image by adding additional glycol, wherein the molecular weight of glycol is less than 5000 and glycol is any one or any combination of ethylene glycol, diethylene glycol, and polyethylene glycol.

While the invention has been described by way of examples and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An ink-jet ink comprising:
polyethylene glycol fatty acid ester;
glycol with a molecular weight less than 5000;
a colorant; and
a solvent.

2. The ink-jet ink of claim 1, wherein said polyethylene glycol fatty acid ester is selected from the group consisting of polyethylene glycol mono-oleate(PEGMO), polyethylene glycol di-oleate(PEGDO), polyethylene glycol mono-stearate(PEGMS), polyethylene glycol di-stearate(PEGDS), polyethene glycol mono-laurate(PEGML), polyethene glycol di-laurate(PEGDL), polyethylene glycol mono-tallate(PEGMT), and polyethylene glycol di-tallate(PEGDT).

3. The ink-jet ink of claim 1, wherein an amount of said polyethylene glycol fatty acid ester is about 0.01 wt %˜15.0 wt %.

4. The ink-jet ink of claim 1, wherein a molecular weight of polyethylene glycol of said polyethylene glycol fatty acid ester is less than 1500.

5. The ink-jet ink of claim 1, wherein said glycol is selected from the group consisting of ethylene glycol, diethylene glycol, and polyethylene glycol.

6. The ink-jet ink of claim 1, wherein an amount of said glycol is about 0.01 wt %˜7.00 wt %.

7. The ink-jet ink of claim 1, wherein the colorant is a disperse pigment.

8. The in jet ink of claim 7, wherein a particle size of the disperse pigment is in the range between 0.001 μm and 1.0 μm.

9. The ink-jet ink of claim 7, wherein an amount of the disperse pigment is in the range between 1.0 wt % and 10.0 wt %.

10. The ink-jet ink of claim 7 further comprises a dispersing agent and an adhesion agent.

11. The ink-jet ink of claim 1, wherein the solvent is an aqueous solvent.

12. The ink-jet ink of claim 11, wherein the aqueous solvent is water.

13. The ink-jet ink of claim 11, wherein an amount of the aqueous solvent is in the range between 50.0 wt % and 95.0 wt %.

14. The ink-jet ink of claim 11 further comprising aqueous organic solvent and inorganic salt.

15. The ink-jet ink of claim 1 furthering comprising a surfactant.

16. The ink-jet ink of claim 15, wherein an amount of the surfactant is in the range between about 0.1 wt % and 10.0 wt %.

17. The ink-jet ink of claim 1 further comprising a humectant.

18. The ink-jet ink of claim 17, wherein the humectant is a water-soluble organic compounds with low volatility.

19. The ink-jet ink of claim 1 further comprising biocide.

20. The ink-jet ink of claim 1 further comprising buffer.
